(19) United States
(12) Patent Application Publication
(10) Pub. No.: US 2006/0074996 A1
(43) Pub. Date: Apr. 6, 2006

(54) System and method for synchronizing data

(75) Inventors: Maria Corbett, Lexington, MA (US); Stephen T. Auriemma, Chelmsford, MA (US); Michael R. O'Brien, Westford, MA (US); Sesha S. Baratham, Acton, MA (US); David Girle, Phoenix, AZ (US)

Correspondence Address: GUERIN & RODRIGUEZ, LLP, 5 MOUNT ROYAL AVENUE, MOUNT ROYAL OFFICE PARK, MARLBOROUGH, MA, 01752, US

(73) Assignee: International Business Machines Corporation, Armonk, NY (US)

(21) Appl. No.: 10/959,004

(22) Filed: Oct. 5, 2004

(51) Int. Cl. G06F 17/30

(52) U.S. Cl. 707/201

(57) ABSTRACT

A system and method for generating a synchronizing data set are described. The method includes receiving a synchronization command by a SyncML complaint device, accessing a data set associated with the SyncML complaint device, filtering the data set in a source adapter to generate a synchronization data set and communicating the synchronization data set to a SyncML compliant synchronization engine.

### FIELD OF THE INVENTION

The invention relates to synchronizing a data set common among multiple electronic devices. More specifically, the invention relates to reducing the size of the data set as part of the synchronization process.

### BACKGROUND OF THE INVENTION

With the advent of electronic devices such as personal computers, personal digital assistants (PDA's), and cellular phones, the need to synchronize a data set among devices arose. Until recently, proprietary methods of data synchronization were employed. To combat this situation, industry participants banded together to create a synchronization standard know as the synchronization markup language (SyncML). At the heart of the synchronization process is a “sync engine”. In simple terms, the sync engine automatically identifies changes, additions, and deletions to the data set that is being synchronized.

As a general rule, synchronization time increases as the size of the data set increases. Sync engines often include filtering capabilities to reduce the size of the data set. The sync engine analyzes the entire data set and filters certain data objects of the data set. If the data set is located separate from the sync engine, the entire data set is transferred to the sync engine for processing. This step increases the synchronization time because the amount of transferred data increases. Increases in synchronization time increase the cost associated with the use of the electronic device. For example, if a subscriber to a pay-per-minute (or a pay-per-data transfer) wireless network issues a sync command from their electronic device, the cost incurred is directly relates to the time required to transfer the data across the network.

### SUMMARY OF THE INVENTION

In one aspect, the invention features a method of generating a synchronization data set. The method includes receiving a synchronization command by a SyncML complaint device, accessing a data set associated with the SyncML complaint device, filtering the data set to generate a synchronization data set, and communicating the synchronization data set to a SyncML compliant synchronization engine.

In some embodiments, the method includes storing a filtering parameter in a device management tree that is accessible by the SyncML complaint device. The filtering can be performed in a source adapter that is resident on the SyncML compliant device.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 depicts an exemplary network environment in which principles of the invention may be practiced.

FIG. 2 is a block diagram of an embodiment of the client system of FIG. 1 which incorporates principles of the invention.

FIG. 3 is a block diagram of an embodiment of the server system of FIG. 1 which incorporates principles of the invention.

FIG. 4 is a flow chart of an embodiment of a method of synchronizing a data set according to principles of the invention.

### DETAILED DESCRIPTION

As a general overview, the Synchronization Markup Language (SyncML) is the result of an industry-wide effort to create a single, common data synchronization protocol optimized for wireless networks. The goal of SyncML is to have networked data that supports synchronization with any mobile electronic device, and mobile electronic devices that support synchronization with any networked data. SyncML works smoothly and efficiently over the Internet (HTTP); wireless session protocol; Object Exchange protocol (Bluetooth, infrared, etc.); email standards (SMTP, POP3, and IMAP); TCP/IP networks; and other proprietary wireless communication protocol. SyncML can be used with data formats ranging from personal data (e.g. vCard & vCalendar) to relational data and XML documents

SyncML enables different synchronization applications to share information utilizing almost any transport type. SyncML enables data synchronization regardless of the programming languages or the synchronization applications used by individual devices. Consequently, communication between applications running in different languages on different devices is possible. Generally, synchronization occurs between a “client” device and a “server” device. The term client device as used herein refers to any device that capable of performing a data synchronization role when an application issues SyncML “request” messages, such as the Sync command in a SyncML message. The term server device as used herein refers to any device issuing SyncML “response” messages (e.g., a Results command in a SyncML message) and performing analysis of the data set. Further details of the SyncML protocol can be found at http://www.opemnobilealliance.org/tech/affiliates/syncml/syncmlindex.html.

Typically after changes are made to a data set on the client device, the entire data set is transferred to the server device for analysis and synchronization with a redundant copy of the data set accessible by the server device. In one aspect of the present invention, prior to passing a synchronization data set to the sync engine the data set is filtered by a source adapter of a SyncML complaint client device to create a synchronization data set. This reduces the overall synchronization time and the amount of processing required by a sync engine, which is present at the server device. Each of the server device and the client device can include a source adaptor. The parameters used for filtering by the source adapter can be configurable and can be included in the synchronization data set.

FIG. 1 shows a network environment 10 in which the invention can be practiced. The environment 10 includes a SyncML compliant client system 14 (also referred to as client system 14) in communication with a SyncML compliant server system 18 (also referred to as server system 18) through a network 20. The client system 14 includes a client SyncML module 22 in communication with various components of the client system 14. The server system 18 includes a server SyncML module 26 in communication with various components of the server system 18 and a device management tree database 30. The device management tree database 30 can be integral with the server system 18 or can be remotely located, as illustrated.

The client system 14 can be any of a variety of electronic devices, such as a personal computer, wireless device, information appliance, cell phone, personal digital assistant (PDA) or other device, that has hardware such as a display screen, one or more input devices (e.g., keypad, stylus, keyboard, mouse, touch-pad, and trackball), a processor for executing application programs and performing the processing of the client SyncML module 22, and sufficient persistent storage for storing such application programs and device information.

The server system 18 can include an electronic device similar to those described for the client system 14. Alternatively, the server system 18 can be a stand alone computing device.

The network 20 can be a local-area network (LAN), a metro-area network (MAN), or wide-area network (WAN), such as the Internet or World Wide Web. Users of the client system 14 connect to the network 20 and in turn the server system 18 through one of a variety of connections, such as standard telephone lines, digital subscriber lines, LAN or WAN links, broadband connections, and wireless connections.

The device management tree database 30 is configured to store provisioning information for a variety of SyncML compliant devices and the current configuration information for the client system 14. The provisioning information can be used by a device manufacturer, a service provider, or a corporate information management department to remotely configure the SyncML compliant devices.

During operation, a user 34 makes changes to data objects (e.g., documents, emails, and contacts) in a source data set of the client system 14 using an application (e.g., word processing, email, database, and similar programs) executing on the client system 14. A user of client system 14 causes through a user interface or the like the client system 14 to begin the synchronization process. In response, the client system SyncML module 22 issues a synchronization request across the network 20 to the server system 18. The server SyncML module 26 sends a response message across the network 20 to the client system 14. The client SyncML module 22 retrieves specific data objects of the source data set to create a synchronization data set and prepares the synchronization data set for transmission to the server system 18. The synchronization data set is processed by the server SyncML module 26 to determine if the synchronization data set includes any modified data objects. Copies of the modified data objects are communicated to a memory in communication with the server system 18 and stored as a replica of the source data set.

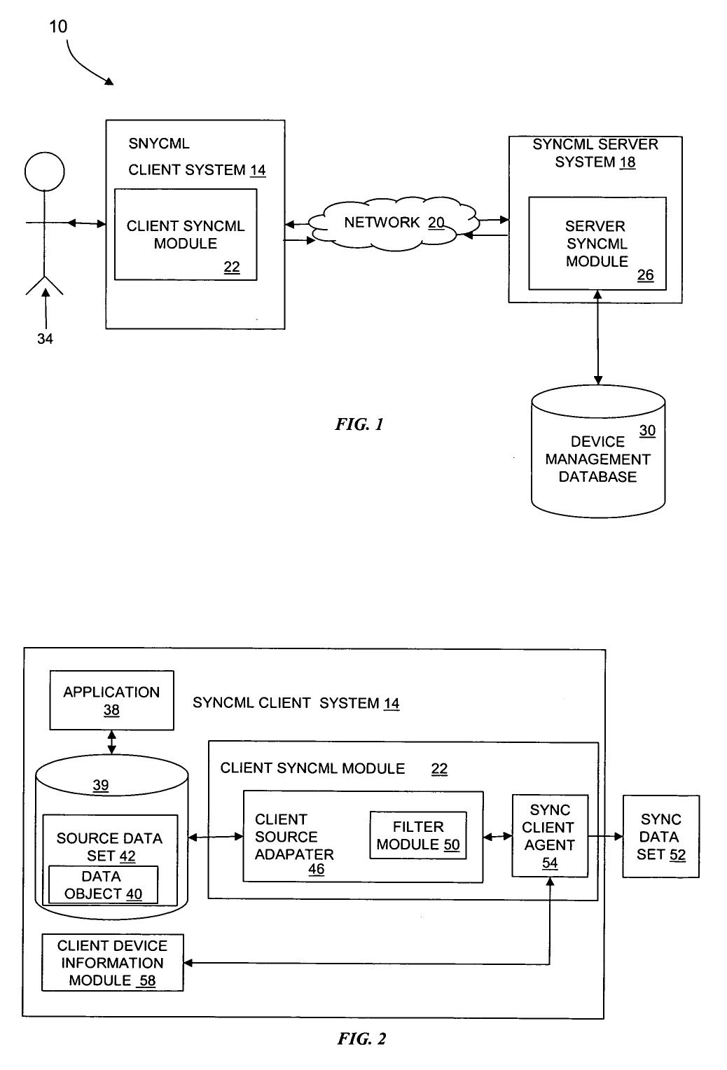

FIG. 2 shows an embodiment of the client system 14 of FIG. 1 that incorporates principles of the invention. The client system 14 includes a processor (not shown) capable of executing operational code such as an operating system (e.g., Windows CE, Palm OS, Unix, Linux, and the like) and an application 38, such as a word processing program or an email program. Also resident on the client system is database 39 configured to store a source data set 42 that contains data objects 40 specific to the application 38. Alternatively, the source data set 42 can be stored in a database that is external to the client system 14. The client SyncML module 22 includes a sync client agent 54 and a client source adapter 46 having a filter module 50. The client source adapter 46 is in communication with the database 39 and is capable of accessing the data objects 40 in the source data set 42 to create a synchronization data set 52. The sync client agent 54 is in communication with the source adapter 46 and a client device information module 58 for storing device information related to the client system 14 as described below.

The application 38 executing on the client system 14 can include software code configured to provide time management (e.g., scheduling) and data processing (e.g., office applications) features. In one embodiment, the application is LOTUS WORKPLACE™ sold by International Business Machine Corporation of Armonk N.Y. The application 38 stores the data objects 40 in the source data set 42. For example, contacts (postal addresses, email addresses, fax numbers, and telephone numbers), emails, documents, and other data objects 40 are stored in the source data set 42. The user 34 of the client system 14 makes changes (i.e., additions, deletions, and modifications) to the data objects 40 of the source data set 42 using a graphical user interface provided as part of the application 38.

The client source adapter 46 includes software code for collecting specific data objects 40 from the source data set 42 to create the synchronization data set 52 and for formatting the synchronization data set 52 for transmission to the server system 18. The filter module 50 provides filtering criteria that defines which data objects 40 are retrieved from the source data set 42 to create the synchronization data set 52. The criteria of the filter module 50 are defined by the user 34 and provide flexibility in the number of data objects 40 transmitted to the server system 18. For example, the user 34 may desire to only synchronize data objects 40 created before a certain date, smaller or larger than a specific size, or data objects 40 having or lacking attachments. The criteria of the filter module 50 can be defined by the user through the use of a graphical user interface (not shown). Alternatively, the filtering criteria can be transmitted to the client system 14 from the server system 18. Transmission of filtering criteria allows someone other than the user 34 of the client system 14 to define the criteria used by the filter module 50.

The device information module 58 includes information related to the configuration of the client system 14. For example, the device information module includes information such as the device type, model number, and manufacture. Service information can also be included in the device information module 58. Examples of service information include synchronization support and format capacities, such as vCard, vCalendar, and iCalendar.

The sync client agent 54 includes software code for managing access to the network 20. In addition, the sync client agent 54 manages SyncML messages transmitted between the client system 14 and the server system 18. The sync client agent 54 is capable of transmitting the synchronization data set 52, which can include the information of the client device management module 58 and the criteria of the filter module 50, from the client system 14 to the server system 18.

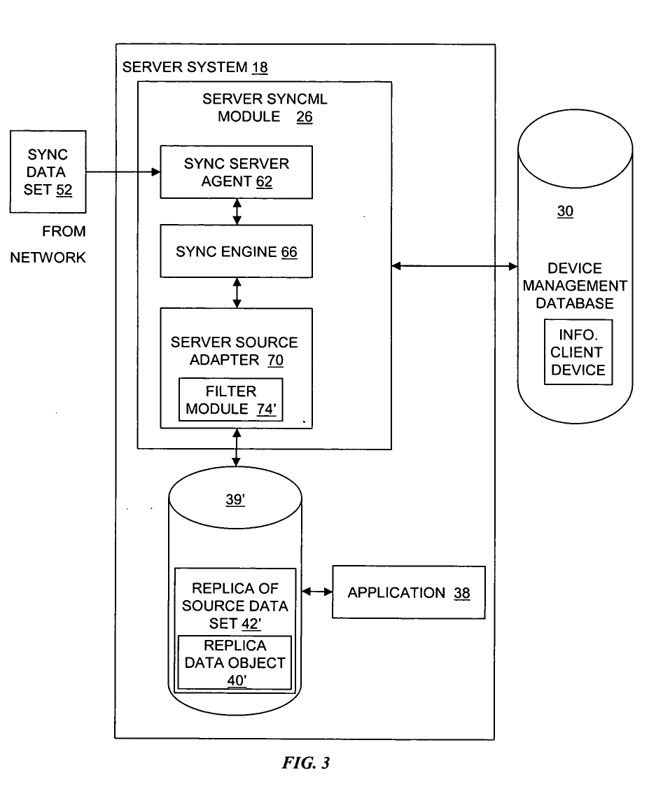

FIG. 3 shows an embodiment of the server system 18 of FIG. 1 which incorporates principles of the invention. The server system 18 includes a replica database 39′ that includes a replica data set 42′ that is a copy of the source data set 42 and includes replica data objects 40′ that are copies of the data objects 40. An application 38′ capable of accessing and modifying the replica data objects 40′ can also be included on the server system 18. The server SyncML module is in communication with the network 20 and receives the synchronization data set 52 from the client system 14.

The server SyncML module 26 includes a sync server agent 62, a sync engine 66, and a server source adapter 70 having a filter module 74. The sync server agent 62 is in communication with the sync engine 66 and the network 20. The sync engine 66 is also in communication with the source adapter 70.

The sync server agent 62 includes software code configured to manage access to the network 20. In addition, the sync server agent 62 is configured to manage SyncML messages transmitted between the client system 14 and the server system 18 and to allow the server system 18 to receive the synchronization data set 52 from the client system 14.

The sync engine 66 includes software code for analyzing the synchronization data set 52. In general, the sync engine 66 is responsible for maintaining consistency between the source data set 42 and the replica 42′ of the source data set. The software code of the sync engine 66 is configured to determine differences (i.e., deletions, additions, and other changes) and conflicts between the data objects 40 of the source data set 42 and the replica data objects 40′ of the replica 42′ of the source data set. The differences between the data objects 40, 40′ are communicated to and stored in the replica database 39′ to maintain consistency between the source data set 42 and the replica 42′ of the source data set.

In the shown server system 18, the server source adapter 70 includes software code configured to communicate the results of the sync engine 66 to the replica 42′ of the source data set. In one embodiment, the server source adapter 70 does not perform additional operations on the synchronization data set 52. However, in another embodiment the server source adapter 70 functions similar to the client source adapter 46 and includes software code for collecting specific data objects 40′ from the replica 42′ source data set to create a synchronization data set 52′. The filter module 74 provides filtering criteria identifying which data objects 40′ are retrieved from the replica 42′ of the source data set and used to create the synchronization data set 52′. The criteria of the filter module 74 are defined by the user of the server system 18. The criteria of the filter 74 can be the same as the criteria of the filter 50 of the client system 14. The criteria of the two filters 74, 50 can be included in the synchronization data set 52 to ensure symmetry between the filters 74, 50. Alternatively, the filter 74 of the server system 18 can have different criteria than the filter 50 of the client system 14. The criteria for the filters 74, 50 can be stored in the device management tree 30.

The device management tree database 30 stores the information of the client device information module 58 and the criteria of the filters 74, 50. A user interface (not shown) or other means of the device management tree database 30 allows the user of the server system 18 to make changes to the information of the client device information module 58 and the criteria of the filters 74, 50. This feature is beneficial because it allows changes to be made at one location that can then be propagated to many client systems 14. For example, if a corporation has a filtering policy any changes to the filter policy can be propagated to each client system 14 when the respective client system 14 performs a synchronization instead of making the changes on each client system 14.

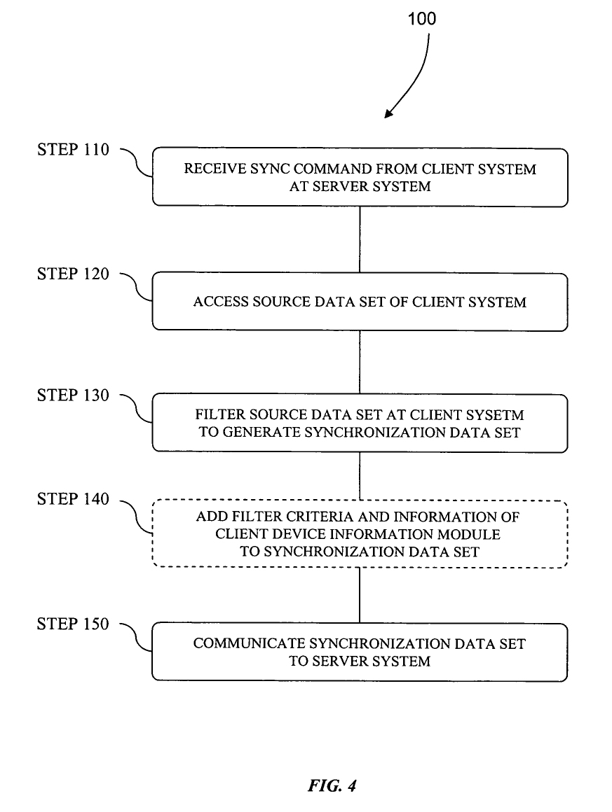

With reference to FIG. 4, an embodiment of a method 100 of operation according to principles of the invention is described. The user 34 of the client system 14 makes changes to a data object 40 of the source data set 42 and causes the client system 14 to issue a sync command. The server system 18 receives (step 110) the sync request from the client system 14. In response to the sync request, a sync session is established between the server system 18 and the client system 14. The client source adapter 46 accesses (step 120) the source data set 42 and filters (step 130), according to the criteria of the filter module 50, the source data set 42 to create the synchronization data set 52. Optionally, the criteria of the filter module 50 and the information of the client system device information 58 are added (step 140) to the synchronization data set 52. The client SyncML module 22 communicates (step 150) the synchronization data set 52 to the server system 18. The synchronization process is completed by the server system 18 and any changes to the data objects 40 of the synchronization data set 52 are stored in the replica 42′ data set of the server system 18.

While the invention has been shown and described with reference to specific preferred embodiments, it should be understood by those skilled in the art that various changes in form and detail may be made therein without departing from the spirit and scope of the invention as defined by the following claims. For example, although described as a method and data file the invention can be embodied as a computer readable medium (e.g., compact disk, DVD, flash memory, and the like) that is sold and distributed in various commercial channels. Also, the computer readable instructions contained on the computer readable medium can be purchased and download across a network (e.g., Internet). Additionally, the invention can be embodied as a computer data signal embodied in a carrier wave for synchronizing a data set.

What is claimed is:

1. A method of generating a synchronization data set, comprising:
receiving a synchronization command by a SyncML complaint device;
accessing a data set associated with the SyncML complaint device;
filtering the data set in accordance with at least one filtering parameter to generate a synchronization data set; and
communicating the synchronization data set to a SyncML compliant synchronization engine.

2. The method of claim 1 wherein filtering comprises removing an item from the data set that is generated before a predetermined date.

3. The method of claim 1 further comprising providing a user interface to a user of the SyncML compliant device and wherein the user can enter the at least one filtering parameter through the user interface.

4. The method of claim 1 further comprising storing the at least one filtering parameter in a device management tree accessible by the SyncML complaint device.

5. The method of claim 1 wherein filtering comprises filtering by a source adapter resident on the SyncML complaint device the data set in accordance with the at least one filtering parameter to generate the synchronization data set.

6. A computer readable medium for generating a synchronization data set, the computer readable medium comprising instructions to cause a processor to:
receive a synchronization command from a SyncML complaint device;
accesses a data set associated with the SyncML complaint device;
filter the data set in accordance with at least one filtering parameter to generate a synchronization data set; and
communicate the synchronization data set to a SyncML compliant synchronization engine.

7. The computer readable medium of claim 5 wherein the instructions to filter comprises instructions to remove an item from the data set that is generated before a predetermined date.

8. The computer readable medium of claim 6 further comprising instructions to provide a user interface to a user of the SyncML compliant device and instructions to facilitate entering of the at least one filtering parameter by the user through the user interface.

9. The computer readable medium of claim 6 further comprising instructions to store the at least one filtering parameter in a device management tree accessible by the SyncML complaint device.

10. The computer readable medium of claim 6 wherein the instructions to filter comprises instructions to filter by a source adapter resident on the SyncML complaint device the data set in accordance with the at least one filtering parameter to generate the synchronization data set.

11. A computer data signal embodied in a carrier wave for generating a synchronization data set, the computer data signal comprising:
program code for receiving a synchronization command by a SyncML complaint device;
program code for accessing a data set associated with the SyncML complaint device;
program code for filtering the data set in accordance with at least one filtering parameter to generate a synchronization data set; and
program code for communicating the synchronization data set to a SyncML compliant synchronization engine.

12. The computer data signal of claim 11 wherein the program code for filtering comprises program code for removing an item from the data set that is generated before a predetermined date.

13. The computer data signal of claim 11 further comprising program code for providing a user interface to a user of the SyncML compliant device, wherein the user can enter the at least one filtering parameter through the user interface.

14. The computer data signal of claim 11 further comprising program code for storing the at least one filtering parameter in a device management tree accessible by the SyncML complaint device.

15. The computer data signal of claim 11 wherein the program code for filtering comprises program code for filtering by a source adapter resident on the SyncML complaint device the data set in accordance with the at least one filtering parameter to generate the synchronization data set.

16. An apparatus for generating a synchronization data set, the apparatus comprising:
means for receiving a synchronization command by a SyncML complaint device;
means for accessing a data set associated with the SyncML complaint device;
means for filtering the data set in accordance with at least one filtering parameter to generate a synchronization data set; and
means for communicating the synchronization data set to a SyncML compliant synchronization engine.

17. The apparatus of claim 16 wherein means for filtering comprises means for removing an item from the data set that is generated before a predetermined date.

18. The apparatus of claim 17 further comprising means for providing a user interface to a user of the SyncML compliant device, wherein the user can enter the at least one filtering parameter through the user interface.

19. The apparatus of claim 16 further comprising means for storing the at least one filtering parameter in a device management tree accessible by the SyncML complaint device.

20. The apparatus of claim 19 wherein the means for filtering comprises means for filtering by a source adapter resident on the SyncML complaint device the data set in accordance with the at least one filtering parameter to generate the synchronization data set.

21. A computer system configured to generate a synchronization data set, the computer system comprising:
a source data set including at least one data object for synchronization;
a processor configured to execute computer readable instructions; and
client SyncML software executable by the processor for generating the synchronization data set, the client SyncML software including:
a filter module configured to store criteria for determining whether the at least one data object is a member of the synchronization data set; and
a source adaptor in communication with a source data set configured to retrieve the at least one data object from the source data set when the data object is a member of the synchronization data set.

22. The method of claim 1 wherein filtering comprises removing an item from the data set that is generated before a predetermined date.
